(19) United States
(12) Patent Application Publication
(10) Pub. No.: US 2006/0082522 A1
(43) Pub. Date: Apr. 20, 2006

(54) Method of driving plasma display panel

(76) Inventors: Min Soo Kim, Gumi-si (KR); Won Jae Kim, Gumi-si (KR); Ki Duck Cho, Gumi-si (KR); Sung Im Lee, Masan-si (KR)

Correspondence Address: Song K. Jung;MCKENNA LONG & ALDRIDGE LLP, 1900 K Street, N.W., Washington, DC, 20006, US

(21) Appl. No.: 11/249,325

(22) Filed: Oct. 14, 2005

(30) Foreign Application Priority Data
Oct. 14, 2004 (KR) P2004-82239

(51) Int. Cl. G09G 3/28

(52) U.S. Cl. 345/67

(57) ABSTRACT

This invention relates to a method of driving a plasma display panel that is adaptive for generating a stable sustain discharge in a low opposition discharge voltage to improve a driving efficiency. A method of driving a plasma display panel, time-dividedly driven by dividing a plurality scan electrodes, sustain electrodes, and address electrodes into an initialization period, an address period, and a sustaining period, according to the present invention includes: applying a positive direct current voltage to the address electrode in the sustaining period; and applying a positive first sustaining pulse to the scan electrode and a positive second sustaining pulse to the sustain electrode, in the sustaining period.

This application claims the benefit of Korean Patent Application No. P2004-82239 filed in Korea on Oct. 14, 2004, which is hereby incorporated by reference.

### BACKGROUND OF THE INVENTION

1. Field of the Invention

This invention relates to a method of driving a plasma display panel, and more particularly, to a method of driving a plasma display panel that is adaptive for generating a stable sustain discharge in a low opposition discharge voltage to improve a driving efficiency.

2. Description of the Related Art

Generally, a plasma display panel (PDP) radiates a phosphorous material using an ultraviolet ray with a wavelength of 147 nm generated upon discharge of an inactive mixture gas such as He+Xe, Ne+Xe or He+Ne+Xe, to thereby display a picture including characters and graphics. Such a PDP is easy to be made into a thin-film and large-dimension type. Moreover, the PDP provides a very improved picture quality owing to a recent technical development. Particularly, since a three-electrode, alternating current (AC) surface-discharge PDP has wall charges accumulated in the surface thereof upon discharge and protects electrodes from a sputtering generated by the discharge, it has advantages of a low-voltage driving and a long life.

Referring to FIG. 1, a discharge cell of the related art three-electrode, AC surface-discharge PDP includes a scan electrode Y and a sustain electrode Z provided on an upper substrate 10, and an address electrode X provided on a lower substrate 18. The scan electrode Y and the sustain electrode Z include transparent electrodes 12Y and 12Z, and metal bus electrodes 13Y and 13Z having a smaller line width than the transparent electrodes 12Y and 12Z and provided at one edge of the transparent electrodes 12Y and 12Z, respectively.

The transparent electrodes 12Y and 12Z are usually formed of indium-tin-oxide (ITO) on the upper substrate 10. The metal bus electrodes 13Y and 13Z are usually formed of a metal such as chrome (Cr) on the transparent electrodes 12Y and 12Z to thereby reduce a voltage drop caused by the transparent electrodes 12Y and 12Z having a high resistance. On the upper substrate 10 provided with the scan electrode Y and the sustain electrode Z in parallel, an upper dielectric layer 14 and a protective film 16 are disposed. Wall charges generated upon plasma discharge are accumulated into the upper dielectric layer 14. The protective film 16 prevents a damage of the upper dielectric layer 14 caused by a sputtering during the plasma discharge and improves the emission efficiency of secondary electrons. This protective film 16 is usually made of magnesium oxide (MgO).

A lower dielectric layer 22 and barrier ribs 24 are formed on the lower substrate 18 provided with the address electrode X. The surfaces of the lower dielectric layer 22 and the barrier ribs 24 are coated with a phosphorous material layer 26. The address electrode X is formed in a direction crossing the scan electrode Y and the sustain electrode Z. The barrier rib 24 is arranged in parallel to the address electrode X to thereby prevent an ultraviolet ray and a visible light generated by a discharge from being leaked to the adjacent cells. The phosphorous material layer 26 is excited by an ultraviolet ray generated during the plasma discharge to generate any one of red, green and blue visible light rays. An inactive mixture gas is injected into a discharge space defined between the upper and lower substrates 10 and 18 and the barrier rib 24.

Such a PDP makes a time-divisional driving of one frame, which is divided into various sub-fields having a different emission frequency, so as to realize gray levels of a picture. Each sub-field is again divided into an initialization period for initializing the entire field, an address period for selecting a scan line and selecting the cell from the selected scan line and a sustaining period for expressing gray levels depending on the discharge frequency.

Herein, the initialization period is again divided into a set-up interval supplied with a rising ramp waveform and a set-down interval supplied with a falling ramp waveform. For instance, when it is intended to display a picture of 256 gray levels, a frame interval equal to 1/60 second (i.e. 16.67 msec) is divided into 8 sub-fields SF1 to SF8 as shown in FIG. 2. Each of the 8 sub-field SF1 to SF8 is divided into an initialization period, an address period and a sustaining period as mentioned above. Herein, the initialization period and the address period of each sub-field are equal for each sub-field, whereas the sustaining period is increased at a ratio of 2ⁿ (wherein n=0, 1, 2, 3, 4, 5, 6 and 7) at each sub-field.

FIG. 3 shows a driving waveform of the PDP applied to two sub-fields.

Referring to FIG. 3, the PDP is divided into an initialization period for initializing the full field, an address period for selecting a cell, and a sustaining period for sustaining a discharge of the selected cell for its driving.

In the initialization period, a rising ramp waveform Ramp-up is simultaneously applied to all the scan electrodes Y in the set-up interval. This rising ramp waveform Ramp-up causes a weak discharge within cells at the full field to generate wall charges within the cells. In the set-down interval, after the rising ramp waveform Ramp-up was supplied, a falling ramp waveform Ramp-down falling from a positive voltage lower than a peak voltage of the rising ramp waveform Ramp-up is simultaneously applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse scan Vscan is sequentially applied to the scan electrodes Y and, at the same time, a positive data pulse data Vd is applied to the address electrodes X. A voltage difference between the scanning pulse scan Vscan and the data pulse data Vd is added to a wall voltage generated in the initialization period to thereby generate an address discharge within the cells supplied with the data pulse data Vd. Wall charges are formed within the cells selected by the address discharge.

Meanwhile, a positive direct current voltage having a sustain voltage level Vs is applied to the sustain electrodes Z during the set-down interval and the address period.

In the sustaining period, a positive sustaining pulse sus is alternately applied to the scan electrodes Y and the sustain electrodes Z. Then, a wall voltage within the cell selected by the address discharge is added to the sustaining pulse sus to thereby generate a sustain discharge taking a surface-discharge type between the scan electrodes Y and the sustain electrode Z whenever each sustaining pulse sus is applied.

Such a sustaining pulse, as shown in FIG. 4, includes: a rising period (between t11 and t2, and t41 and t5) when the sustaining pulse rises; a sustaining period (between t2 and t3, and t5 and t61) -when the sustaining pulse is sustaining; and a falling period (between t31 and t4, and t61 and t7) when the sustaining pulse is falling.

Hereinafter, a principle of generating the sustain discharge generated in the scan electrode Y and the sustain electrode Z in accordance with an interval of the sustaining pulse shown in FIG. 4 will be described with the aid of a voltage closed curve having a hexagonal shape as shown in FIG. 5. Herein, the voltage closed curve is used as a scheme for measuring a discharge generation principle and a voltage margin of the PDP.

In FIG. 5, a hexagon area at the interior of the voltage closed curve is a region where a cell voltage of an interior of the discharge cell is moved. When the cell voltage is located at an interior area, a discharge is not generated. In other words, when the cell voltage is located at an exterior area of the hexagon, a discharge is generated. Further, the interior of the voltage closed curve is a non-discharge area that a discharge is not generated at the interior of the discharge cell, and the exterior of the voltage closed curve is a discharge area that a discharge is generated at the interior of the discharge cell. Herein, Y(−) represents a motion direction of the cell voltage when a negative voltage is applied to the scan electrode Y. Similarly, Y(+), X(+), X(−), Z(+) or Z(−) represents a motion direction of the cell voltage when a negative or positive voltage is applied to the scan electrode Y, the address electrode X or the sustain electrode Z.

Further, Vtxy indicated at the first quarter-face opposition discharge area of the voltage closed curve graph represents a voltage, which a discharge between the address electrode X and the scan electrode Y is being initiated, when a voltage is applied to the address electrode X. Thus, a straight line representing the first quarter-face opposition discharge area of the voltage closed curve graph is set by a length as much as voltage which a discharge between the address electrode X and the scan electrode Y is being initiated. And, Vtzy indicated at the first quarter-face surface-discharge area of the voltage closed curve graph represents a voltage, which a discharge between the sustain electrode Z and the scan electrode Y is being initiated, when a voltage is applied to the sustain electrode Z. Similarly, Vtxz, Vtzx, Vtyz and Vtyx respectively represent a discharge initiation voltage between the electrodes. Meanwhile, voltages of Vtxy, Vtzy, Vtxz, Vtzx, Vtyz and Vtyx are differentiated in accordance with panel, e.x, cell dimension and a process deviation. Accordingly, a shape of the voltage closed curve becomes slightly differentiated.

To explain an operation procedure in the sustaining period, a wall charge of an on cells, i.e., a discharge cells in which an address discharge is generated, is located at an ‘A’ portion, X(−) axis, as shown in FIG. 6. In other words, the wall voltage of the on cells is located at the ‘A’ portion in the point of t1 time of the sustaining pulse shown in FIG. 4. Thereafter, at the point of t11 time when the positive sustaining pulse is applied to the scan electrode Y, the wall voltage of the on cells located at the ‘A’ portion is added to a voltage value of the positive sustaining pulse, so that the wall voltage of the on cells moves to Y(+) axis through a surface-discharge area located at the third quarter-face of the graph as shown in FIG. 7. In this connection, the wall voltage of the on cells moves to a ‘B’ portion by the sustaining pulse rising to the positive polarity at the point of t2 time and the wall voltage of the on cells located at the ‘A’ portion, and a sustain discharge between the scan electrode Y and the sustain electrode Z is generated in the discharge cells. At the point of t3 time when the sustaining pulse is maintained, wall charges is accumulated in the sustain electrode Z, so that a discharge is erased in the scan electrode Y, thus, the wall voltage of the on cells moves from the ‘B’ portion to a ‘C’ portion. And then, at the point of t4 time when the sustaining pulse applied to the scan electrode Y is eliminated, the wall voltage of the on cells moves from the ‘C’ portion to a ‘D’ portion by the voltage value of the eliminated sustaining pulse.

At the point of t41 time when the sustaining pulse is applied to the sustain electrode Z, the wall voltage of the on cells located at the ‘D’ portion is added to a voltage value of the positive sustaining pulse, so that the wall voltage of the on cells moves to Z(+) axis through a surface-discharge area located at the first quarter-face of the graph as shown in FIG. 8. Accordingly, the wall voltage of the on cells moves to an ‘E’ portion by the sustaining pulse rising to the positive polarity at the point of t5 time and the wall voltage of the on cells located at the ‘D’ portion, and a sustain discharge between the sustain electrode Z and the scan electrode Y is generated in the discharge cells. At the point of t6 time when the sustaining pulse is maintained, wall charges are accumulated in the scan electrode Y, so that a discharge is erased in the sustain electrode Z, thus, the wall voltage of the on cells located at the ‘E’ portion moves to the ‘C’ portion. And then, at the point of t7 time when the sustaining pulse applied to the sustain electrode Z is eliminated, the wall voltage of the on cells moves from the ‘C’ portion to the ‘A’ portion by the voltage value of the eliminated sustaining pulse.

In real, the PDP repeats the processes of a predetermined frequency like FIG. 7 and FIG. 8 during the sustaining period to thereby cause sustain discharges. Accordingly, the cells in which the discharge is generated repeat the process shown in FIG. 6.

However, the PDP applying such a driving waveform has a disadvantage of a low driving efficiency in a panel having an opposition discharge of a low condition in characteristics such as a secondary electron emission coefficient of MgO protective film, a composition of MgO protective film, a discharge initiate voltage, a height of barrier rib and the like. For instance, in a PDP employing a barrier rib structure having a low height, i.e., a low barrier rib structure for a high speed addressing, since a sustain margin can not be stably secured, a driving efficiency becomes reduced. In other words, if dimension of the barrier rib 24 becomes small in the discharge cell structure of the PDP shown in FIG. 1, then the opposition discharges between the address electrode X and the scan electrode Y and between the address electrode X and the sustain electrode Z become reduced, so that a margin of the opposition discharge by the sustaining pulse supplied to the scan electrode Y and the sustain electrode Z becomes reduced. Further, the wall voltage of the discharge cell, in which the address discharge is generated, separates from the hexagonal area of the voltage closed curve interior due to the decrease of the opposition discharge voltage, so that a self-erasing discharge is generated in the discharge cells. Accordingly, the sustain margin is reduced, so that the driving efficiency becomes reduced.

### SUMMARY OF THE INVENTION

Accordingly, it is an object of the present invention to provide a method of driving a plasma display panel that is adaptive for generating a stable sustain discharge in a low opposition discharge voltage to improve a driving efficiency.

In order to achieve these and other objects of the invention, there is provided with a method of driving a plasma display panel, time-dividedly driven by dividing a plurality scan electrodes, sustain electrodes, and address electrodes into an initialization period, an address period, and a sustaining period, comprising: applying a positive direct current voltage to the address electrode for the sustaining period; and applying a first positive sustaining pulse to the scan electrode and a second positive sustaining pulse to the sustain electrode for the sustaining period.

The voltage of the first sustaining pulse is larger than the voltage capable of causing an opposition discharge between the address electrodes and the scan electrodes or the address electrodes and the sustain electrodes.

The direct current voltage is substantially equal to the data voltage applied to the address electrodes for the address period to select a discharge cell.

The direct current voltage is smaller than the sustain voltage.

According to the present invention, there is provided with a method of driving a plasma display panel, time-dividedly driven by dividing a plurality scan electrodes, sustain electrodes, and address electrodes into an initialization period, an address period, and a sustaining period, comprising: alternatively applying a positive sustaining pulse to the scan electrodes and the sustain electrodes for the sustaining period; and supplying a positive auxiliary pulse corresponding to the sustaining pulse to the address electrodes at least one time.

According to the present invention, there is provided with a method of driving a plasma display panel, time-dividedly driven by dividing a plurality scan electrodes, sustain electrodes, and address electrodes into an initialization period, an address period, and a sustaining period, comprising: alternatively applying a negative sustaining pulse to the sustain electrodes and the scan electrodes for the sustaining period.

According to the present invention, there is provided with a method of driving a plasma display panel including a sustain electrode, an address electrode and a scan electrode based on a non-discharge area defined on the coordinates having X, Y and Z axes and a discharge area defined at exterior of the non-discharge area, wherein the Z axis represents the voltage applied to the sustain electrode, the X axis crossing the Z axis represents a voltage applied to the address electrode, and the Y axis passes through a point of cross of both the Z axis and the X axis and exists at a first quarter-face and a third quarter-face of an orthogonal coordinates formed of the Z axis and the X axis, comprising: applying a first voltage to the address electrode for the sustaining period to move a wall voltage of an on cell existed at the discharge area near the Z axis to a first location of the non-discharge area; applying a second voltage to the scan electrode to move the wall charge of the on cell existed at the first location of the non-discharge area to a first location of the discharge area; maintaining a voltage of the scan electrode with the second voltage and inducing an accumulation of wall charge on the sustain electrode to move the wall voltage of the on cell from the first location of the discharge area to a second location of the non-discharge area; lowering the voltage of the scan electrode to move the wall voltage of the on cell from the second location of the non-discharge area to a third location of the non-discharge area; applying a third voltage to the sustain electrode to move the wall voltage of the on cell from the third location of the non-discharge area to a second location of the discharge area; maintaining the a voltage of the sustain electrode with the third voltage and inducing an accumulation of a wall charge on the scan electrode to return the wall voltage of the on cell from the second location of the discharge area to the second location of the non-discharge area; and lowering the voltage of the sustain electrode to return the wall charge of the on cell from the second location of the non-discharge to the first location of the discharge area.

According to the present invention, there is provided with a method of driving a plasma display panel including a sustain electrode, an address electrode and a scan electrode based on a non-discharge area defined on the coordinates having X, Y and Z axes and a discharge area defined at exterior of the non-discharge area, wherein the Z axis represents the voltage applied to the sustain electrode, the X axis crossing the Z axis represents a voltage applied to the address electrode, and the Y axis passes through a point of cross of both the Z axis and the X axis and exists at a first quarter-face and a third quarter-face of an orthogonal coordinates formed of the Z axis and the X axis, comprising: a first step of applying a first voltage to the scan electrode for the sustaining period to move a wall voltage of an on cell from a first location of the discharge area to a second location of the discharge area; a second step of applying a second voltage to the address electrode while a voltage of the scan electrode is maintained with the first voltage to move the wall voltage of the on cell from the second location of the discharge area to a third location of the discharge area; a third step of maintaining the voltages of both the scan electrode and the address electrode and inducing an accumulation of a wall charge on the sustain electrode to move the wall voltage of the on cell from the third location of the discharge area to a first location of the non-discharge area; a fourth step of lowering the voltage of the scan electrode while the voltage of the address electrode is maintained with the second voltage to move the wall voltage of the on cell from the first location of the non-discharge area to a fourth location of the discharge area; a fifth step of lowering the voltage of the address electrode while the voltage of the scan electrode is lowered to move the wall voltage of the on cell from the fourth location of the discharge area to a second location of the non-discharge area; a sixth step of applying a third voltage to the sustain electrode to move the wall voltage of the on cell from the second location of the non-discharge to a fifth location of the discharge area; a seventh step of applying the second voltage to the address electrode while the voltage of the sustain electrode is maintained with the third voltage to move the wall voltage of the on cell from the fifth location of the discharge area to a sixth location of the discharge area; an eighth step of maintaining the voltage both the sustain electrode and the address electrode to return the wall voltage of the on cell from the sixth location of the discharge area to the first location of the non-discharge area; a ninth step of lowering the voltage of the sustain electrode while the voltage of the address electrode is maintained to return the wall voltage of the on cell from the first location of the non-discharge area to the first location of the discharge area; a tenth step of lowering the voltage of the address electrode while the voltage of the sustain electrode is lowered to move the wall charge of the on cell from the first location of the discharge area to a third location of the non-discharge area; an eleventh step of applying the first voltage to the scan electrode to move the wall voltage of the on cell from the second location area of the non-discharge area to a seventh location of the discharge area; a twelfth step of applying the second voltage to the address electrode while the voltage of the scan electrode is maintained with the first voltage to move the wall voltage of the on cell form the seventh location of the discharge area to an eighth location of the discharge area; a thirteenth step of maintaining the voltage of both the scan electrode and the address electrode and inducing an accumulation of a wall charge on the sustain electrode to return the wall voltage of the on cell form the eighth location of the discharge area to the first location of the non-discharge area; a fourteenth step of lowering the voltage of the scan electrode while the voltage of the address electrode is maintained to move the wall voltage of the on cell from the first location of the non-discharge area to the fourth location of the discharge area; a fifteenth step of lowering the voltage of the address electrode while the voltage of the scan electrode is lowered to move the wall voltage of the on cell from the fourth location of the discharge area to the second location of the non-discharge area; a sixteenth step of applying the third voltage to the sustain electrode to move the wall voltage of the on cell from the second location of the non-discharge area to the fifth location of the discharge area; a seventeenth step of applying the second voltage to the address electrode while the voltage of the sustain electrode is maintained with the third voltage to move the wall charge of the on cell form the fifth location of the discharge area to the sixth location of the discharge area; an eighteenth step of maintaining the voltage of both the sustain electrode and the address electrode to return the wall voltage of the on cell from the sixth location of the discharge area to the first location of the non-discharge area; a nineteenth step of lowering the voltage of the sustain electrode while the voltage of the address electrode is maintained to move the wall voltage of the on cell from the first location of the non-discharge area to the first location of the discharge area; and a twentieth step of lowering the voltage of the address electrode while the voltage of the sustain electrode is lowered to move the wall voltage of the on cell from the first location of the discharge area to the third location of the non-discharge area.

According to the present invention, there is provided with a method of driving a plasma display panel including a sustain electrode, an address electrode and a scan electrode based on a non-discharge area defined on the coordinates having X, Y and Z axes and a discharge area defined at exterior of the non-discharge area, wherein the Z axis represents the voltage applied to the sustain electrode, the X axis crossing the Z axis represents a voltage applied to the address electrode, and the Y axis passes through a point of cross of both the Z axis and the X axis and exists at a first quarter-face and a third quarter-face of an orthogonal coordinates formed of the Z axis and the X axis, comprising: applying a negative first voltage to the sustain electrode for the sustaining period to move a wall voltage of an on cell existed at a first initialization location of the non-discharge area to a first location of the discharge area; maintaining a voltage of the sustain electrode and inducing an accumulation of a wall charge on the scan electrode to move the wall voltage of the on cell from the first location of the discharge area to a first location of the non-discharge area; lowering the voltage of the sustain electrode to move the wall voltage of the on cell from the first location of the non-discharge area to a second location of the non-discharge area; applying a negative second voltage to the scan electrode to move the wall voltage of the on cell from a second initialization location of the non-discharge area to a second location of the discharge area; maintaining a voltage of the scan electrode and inducing an accumulation of a wall charge on the sustain electrode to return the wall voltage of the on cell from the second location of the discharge area to a second location of the non-discharge area; and lowering the voltage of the scan electrode to return the wall voltage of the on cell from the second location of the non-discharge area to a third location of the non-discharge area.

### BRIEF DESCRIPTION OF THE DRAWINGS

These and other objects of the invention will be apparent from the following detailed description of the embodiments of the present invention with reference to the accompanying drawings, in which:

FIG. 1 is a perspective view showing a discharge cell structure of a related art three-electrode, AC surface-discharge plasma display panel;

FIG. 2 is a diagram showing an example of brightness weight of a sub-field included one frame;

FIG. 3 is a waveform diagram showing a driving waveform of the related art plasma display panel;

FIG. 4 is a diagram showing a timing of pulses applied to a scan electrode, a sustain electrode, and an address electrode in a sustaining period in the driving waveform shown in FIG. 3;

FIG. 5 is a graph showing a position of the wall voltage at the discharge cell in which an address discharge is generated;

FIG. 6 is a graph showing a motion of the wall voltage of the discharges cells in accordance with the timing of the pulses shown in FIG. 4;

FIGS. 7 and 8 are graphs showing a process of generating a sustain discharge when a sustaining pulse is applied to the discharge cells shown in FIG. 5;

FIG. 9 is a graph showing a motion of the wall voltage of the discharge cells in the plasma display panel having a low opposition discharge voltage;

FIG. 10 is a diagram showing a driving waveform of a plasma display panel according to an embodiment of the present invention;

FIG. 11 is a diagram showing a timing of pulses applied to a scan electrode, a sustain electrode, and an address electrode in a sustaining period in the driving waveform shown in FIG. 10;

FIG. 12 is a graph showing a motion of the wall voltage of the discharge cells in accordance with the timing of the pulses shown in FIG. 11.

FIG. 13 is a graph showing a motion of the wall voltage of the discharge cells in accordance with a voltage applied to the address electrode in the sustaining period;

FIG. 14 is a diagram showing a driving waveform of a plasma display panel according to another embodiment of the present invention;

FIG. 15 is a diagram showing a timing of pulses applied to a scan electrode, a sustain electrode, and an address electrode in a sustaining period in the driving waveform shown in FIG. 14;

FIGS. 16A and 16B are graphs showing a motion of the wall voltage of the discharge cells according to the timing of the pulses shown in FIG. 15;

FIG. 17 is a diagram showing a driving waveform of a plasma display panel according to still another embodiment of the present invention;

FIG. 18 is a diagram showing a timing of pulses applied to a scan electrode, a sustain electrode, and an address electrode in a sustaining period in the driving waveform shown in FIG. 17;

FIG. 19 is graph showing a motion of the wall voltage of the discharge cells according to the timing of the pulses shown in FIG. 18; and

FIG. 20 is a diagram showing a driving apparatus for generating a driving waveform of the plasma display panel shown in FIGS. 10, 14, and 17.

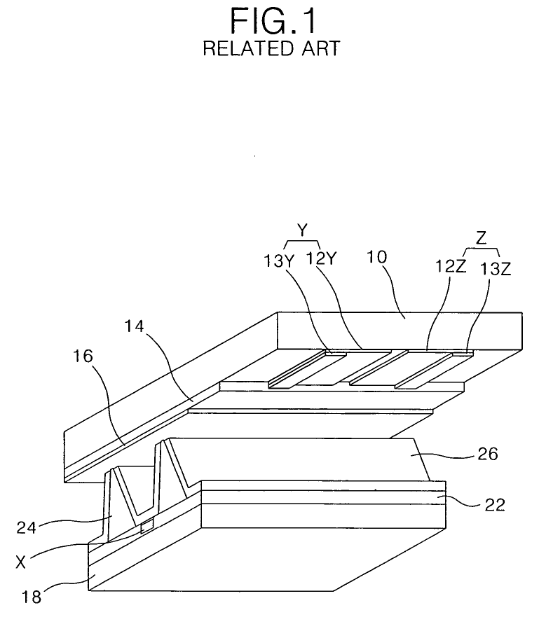

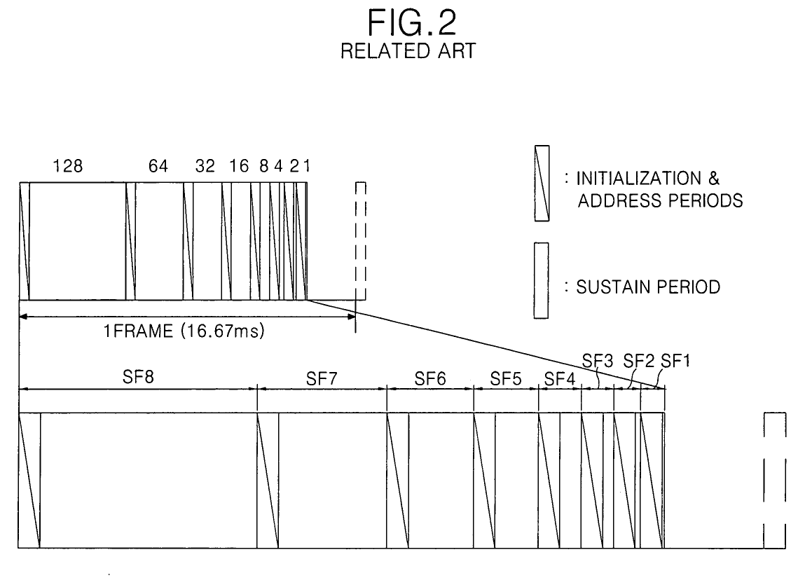

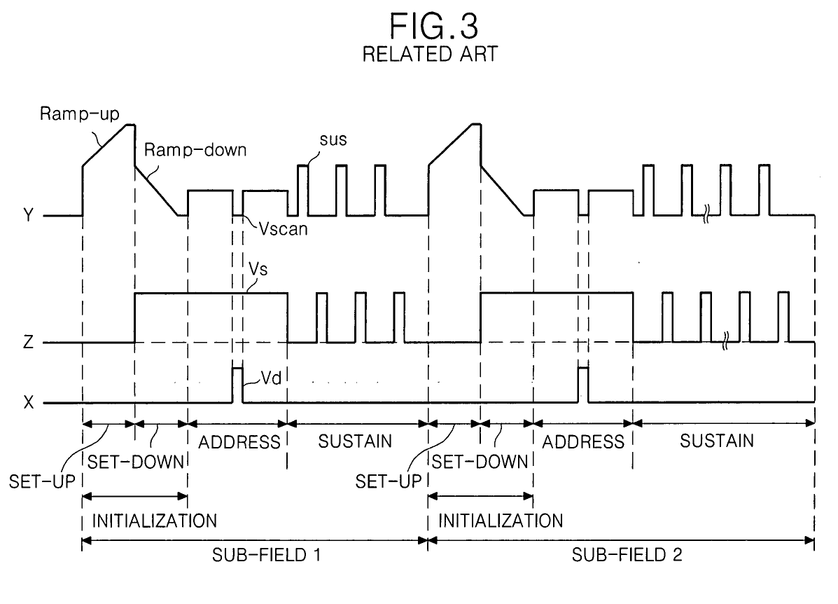

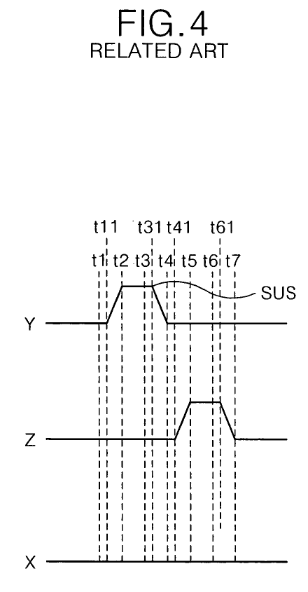

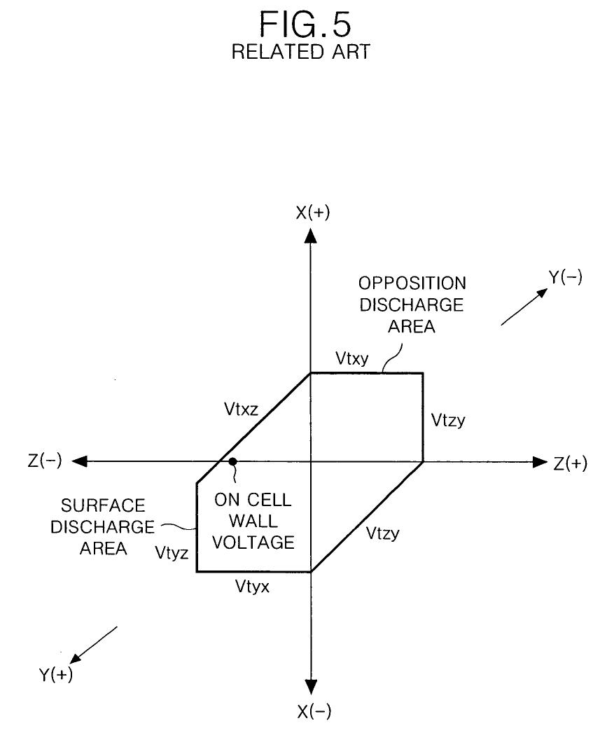

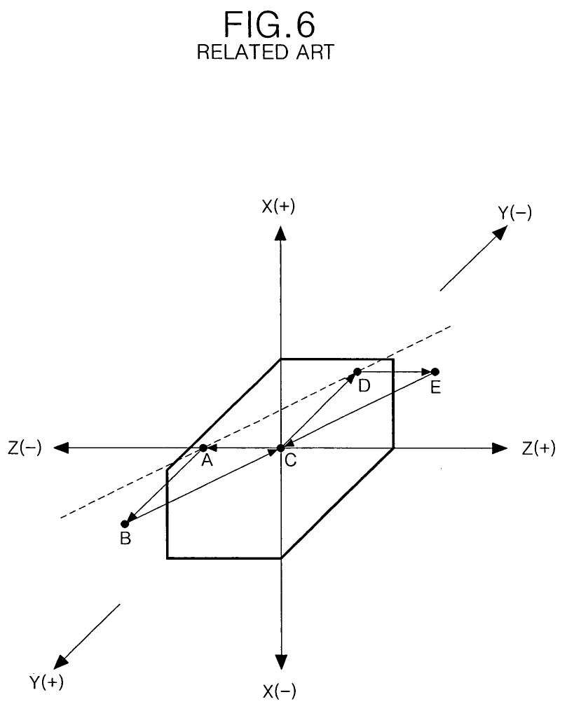

### DETAILED DESCRIPTION OF THE PREFERRED EMBODIMENT

Reference will now be made in detail to the preferred embodiments of the present invention, examples of which are illustrated in the accompanying drawings.

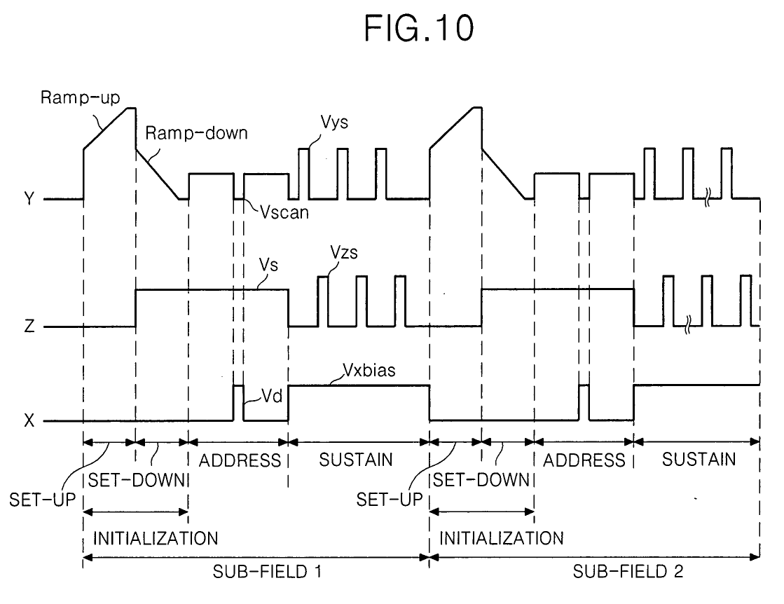

Hereinafter, the preferred embodiments of the present invention will be described in detail with reference to FIGS. 10 to 20.

FIG. 10 is a waveform showing a method of driving a plasma display panel PDP according to an embodiment of the present invention.

Referring to FIG. 10, the method of driving the PDP is divided into an initialization period for initializing the full field, an address period for selecting a cell, and a sustaining period for sustaining a discharge of the selected cell for its driving.

In the initialization period, a rising ramp waveform Ramp-up is simultaneously applied to all the scan electrodes Y in the set-up interval. This rising ramp waveform Ramp-up causes a weak discharge within cells at the full field to generate wall charges within the cells. In the set-down interval, after the rising ramp waveform Ramp-up was supplied, a falling ramp waveform Ramp-down falling from a positive voltage lower than a peak voltage of the rising ramp waveform Ramp-up is simultaneously applied to the scan electrodes Y. The falling ramp waveform Ramp-down causes a weak erasure discharge within the cells, to thereby erase spurious charges of wall charges and space charges generated by the set-up discharge and uniformly leave wall charges required for the address discharge within the cells of the full field.

In the address period, a negative scanning pulse Vscan is sequentially applied to the scan electrodes Y and, at the same time, a positive data pulse Vd is applied to the address electrodes X. A voltage difference between the scanning pulse Vscan and the data pulse Vd is added to a wall voltage generated in the initialization period to thereby generate an address discharge within the cells supplied with the data pulse Vd. Wall charges are formed within the cells selected by the address discharge.

Meanwhile, a positive direct current voltage having a sustain voltage level Vs is applied to the sustain electrodes Z during the set-down interval and the address period.

In the sustaining period, first and second sustaining pulses Vys and Vzs are alternately applied to the scan electrodes Y and the sustain electrodes Z. In this connection, the first and the second sustaining pulses Vys and Vzs, applied to the scan electrodes Y and the sustain electrodes Z, are respectively larger than a first opposition discharge voltage Vtxy and a second opposition discharge voltage Vtxz. Herein, the first opposition discharge voltage Vtxy is a voltage when a discharge is initiated between the address electrode X and the scan electrode Y, and the second opposition discharge voltage Vtxz is a voltage when a discharge is initiated between the address electrode X and the sustain electrode Z. In other words, the first sustaining pulse Vys should be larger than the first opposition discharge voltage Vtxy in order to generate an opposition discharge between the address electrode X and the scan electrode Y. Further, the second sustaining pulse Vzs should be lager than the second opposition discharge voltage Vtxz in order to generate an opposition discharge between the address electrode X and the sustain electrode Z. In this connection, the first and the second sustaining pluses Vys and Vzs are formed in the same dimension each other.

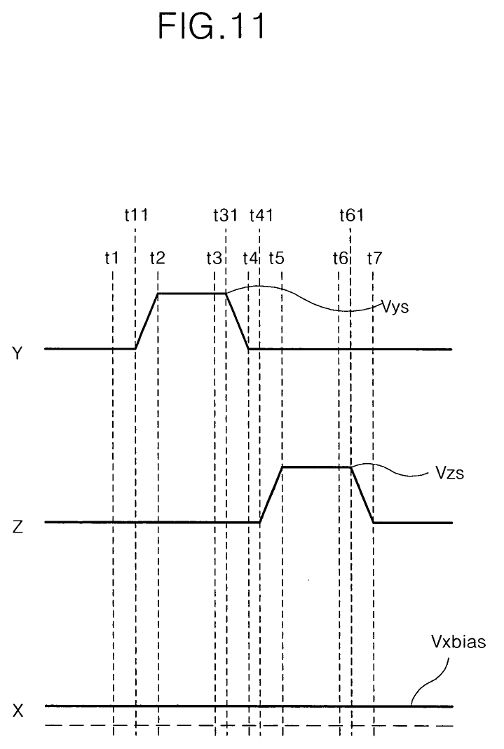

Such the first and the second sustaining pulses Vys and Vzs, as shown in FIG. 11, includes: a rising period (between t11 and t2, and t41 and t5) when the sustaining pulse rises; a sustaining period (between t2 and t31, and t5 and t61) when the sustaining pulse is sustaining; and a falling period (between t31 and t4, and t61 and t7) when the sustaining pulse is falling. As the wall voltage within the cell is added to the first and the second sustaining pulses Vys and Vzs, a sustain discharge is generated between the scan electrode Y and the sustain electrode Z in a surface-discharge type in the cell selected by the address discharge whenever the sustaining pulses Vys and Vzs are applied. Further, a positive direct current voltage Vxbias is applied to the address electrodes X in the sustaining period.

The positive direct current voltage Vxbias moves the wall charge of the on cells located at the exterior of the hexagonal voltage closed curve into the interior of the voltage closed curve. Accordingly, a self-erasing discharge generated in the discharge cells located at the exterior of the voltage closed curve in the sustaining period can be prevented, so that it is possible to secure a stable sustain margin. Herein, the positive direct current voltage Vxbias applied to the address electrodes X might be changed. Accordingly, in the method of driving the PDP according to the embodiment of the present invention, the positive direct current voltage Vxbias having the same dimension as the data pulse Vd applied to the address electrode X in the address electrode is supplied to the address electrode X.

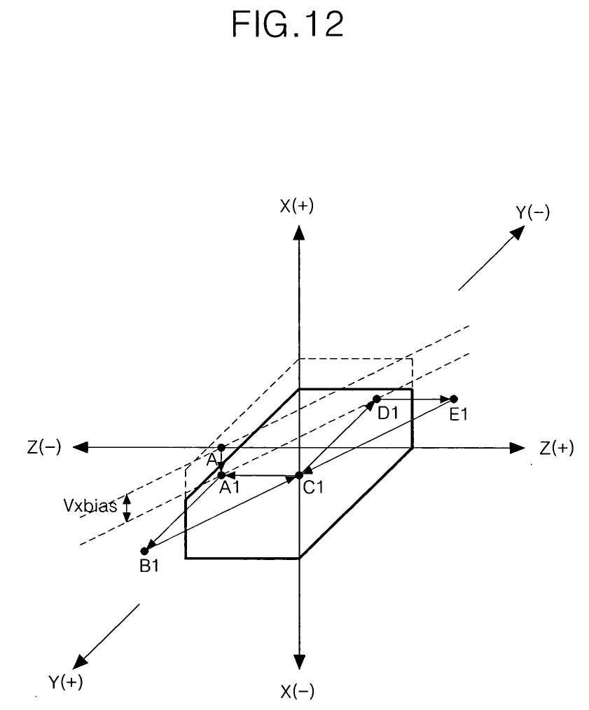

A principle of generating the sustain discharge generated in the scan electrode Y and the sustain electrode Z in accordance with an interval of the sustaining pulse shown in FIG. 11 will be described with the aid of a voltage closed curve having a hexagonal shape as shown in FIG. 12.

In FIG. 12, a hexagon area at the interior of the voltage closed curve is a region where a cell voltage of an interior of the discharge cell is moved. When the cell voltage is located at the hexagon interior area, a discharge is not generated. In other words, when the cell voltage is located at a hexagon exterior area, a discharge is generated. Further, the interior of the voltage closed curve is a non-discharge area that a discharge is not generated at the interior of the discharge cell, and the exterior of the voltage closed curve is a discharge area that a discharge is generated at the interior of the discharge cell. Herein, Y(−) represents a motion direction of the cell voltage when a negative voltage is applied to the scan electrode Y. Similarly, Y(+), X(+), X(−), Z(+) or Z(−) represents a motion direction of the cell voltage when a negative or positive voltage is applied to the scan electrode Y, the address electrode X or the sustain electrode Z.

Further, Vtxy indicated at the first quarter-face opposition discharge area of the voltage closed curve graph represents a voltage, which a discharge between the address electrode X and the scan electrode Y is initiated, when a voltage is applied to the address electrode X. Thus, a straight line representing the first quarter-face opposition discharge area of the voltage closed curve graph is set by a length as much as voltage which a discharge between the address electrode X and the scan electrode Y is initiated. And, Vtzy indicated at the first quarter-face surface-discharge area of the voltage closed curve graph represents a voltage, which a discharge between the sustain electrode Z and the scan electrode Y is initiated, when a voltage is applied to the sustain electrode Z. Similarly, Vtxz, Vtzx, Vtyz and Vtyx respectively represent a discharge initiate voltage between the electrodes. Meanwhile, voltages of Vtxy, Vtzy, Vtxz, Vtzx, Vtyz and Vtyx are differentiated in accordance with panel, e.x, cell dimension and a process deviation. Accordingly, a shape of the voltage closed curve becomes slightly differentiated.

Generally, a wall voltage of discharge cells(on cells) in which an address discharge is generated upon a high-speed addressing drive, is located at an ‘A’ portion, X(−) axis, as shown in FIG. 12. In this connection, the wall voltage of the on cells moves from the ‘A’ portion to an ‘A1’ portion by the positive direct current voltage Vxbias applied to the address electrode X at the point of t1 time.

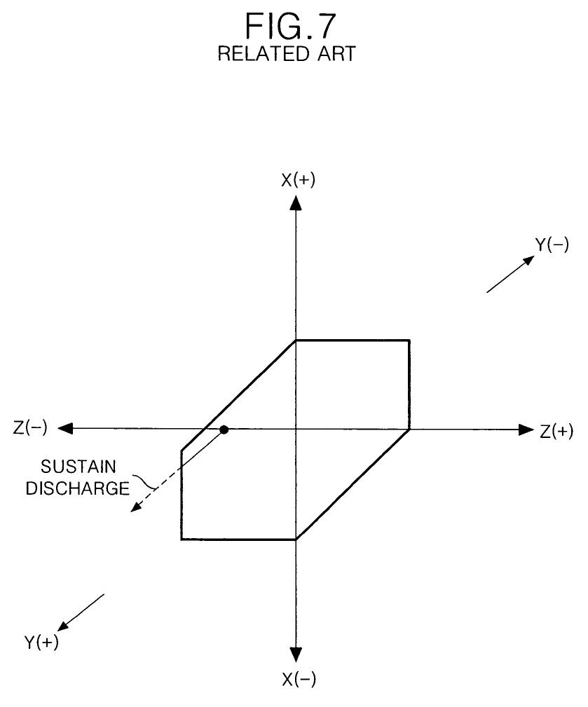

Thereafter, the wall voltage of the on cells located at the ‘A1’ portion is added to the positive first sustaining pulse Vys, so that the wall voltage of the on cells moves to Y(+) axis via a surface-discharge area located at the third quarter-face of the graph as shown in FIG. 7. In this connection, the wall voltage of the on cells moves from the ‘A1’ portion to a ‘B1’ portion by the first sustaining pulse Vys rising to the positive polarity and the wall voltage of the on cells located at the ‘A1’ portion, and a sustain discharge between the scan electrode Y and the sustain electrode Z is generated in the discharge cells, at the point of t2 time. At the point of t3 time when the first sustaining pulse Vys is maintained, wall charges are accumulated in the sustain electrode Z, so that a discharge is erased in the scan electrode Y, thus, the wall voltage of the on cells moves from the ‘B1’ portion to a ‘C1’ portion. And then, at the point of t4 time when the first sustaining pulse Vys applied to the scan electrode Y is eliminated, the wall voltage of the on cells moves from the ‘C1’ portion to a ‘D1’ portion by the eliminated first sustaining pulse Vys and the direct current voltage Vxbias applied to the address electrode X.

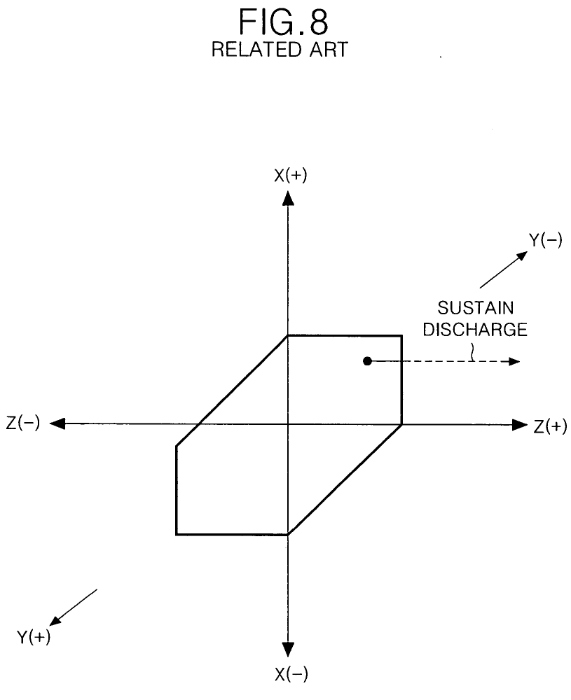

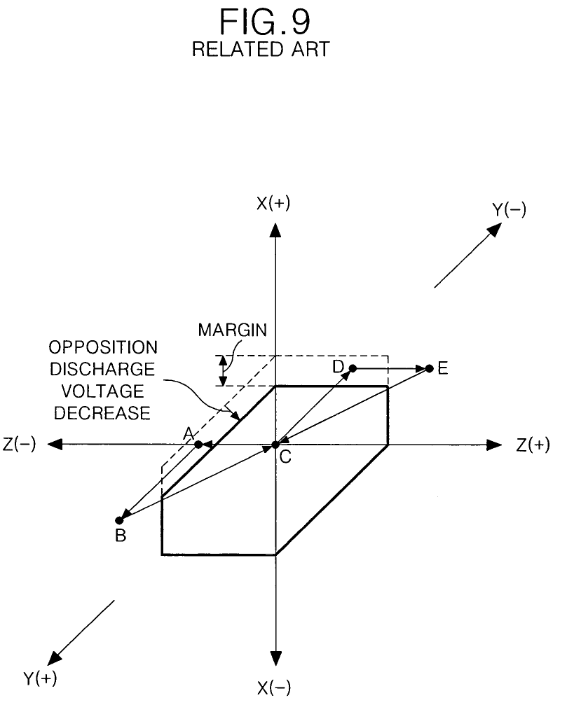

At the point of t41 time when the second sustaining pulse Vzs is applied to the sustain electrode Z, the wall voltage of the on cells located at the ‘D1’ potion is added to the second sustaining pulse Vzs, so that the wall voltage moves to Z(+) axis through a surface-discharge area located at the first quarter-face of the graph as shown in FIG. 8. In this connection, at the point of t5 time, the wall voltage of the on cells moves from the ‘D1’ potion to an ‘E1’ portion by the second sustaining pulse Vzs rising to the positive polarity and the wall voltage of the on cells located at the ‘D1’ portion, and a sustain discharge between the sustain electrode Z and the scan electrode Y is generated in the discharge cells. At the point of t6 time when the second sustaining pulse Vzs is maintained, wall charges are accumulated in the scan electrode Y, so that a discharge is erased in the sustain electrode Z, thus, the wall voltage of the on cells moves from the ‘E1’ portion to the ‘C1’ portion. And then, at the point of t7 time when the second sustaining pulse Vzs applied to the sustain electrode Z is eliminated, the wall voltage of the on cells moves from the ‘C1’ portion to the ‘A1’ portion by the voltage value of the eliminated second sustaining pulse Vzs.

In real, the PDP repeats the processes of a predetermined frequency like FIG. 7 and FIG. 8 during the sustaining period to thereby cause sustain discharges. Accordingly, the cells in which the discharge is generated repeat the process shown in FIG. 12.

In the method of driving the PDP according to the present invention, the positive direct current voltage Vxbias is applied to the address electrode X in the sustaining period to thereby locate the wall voltage of the on cells at the interior of the hexagonal voltage closed curve by the applied positive direct current voltage Vxbias. Accordingly, the self-erasing discharge generated in the discharges upon the high-speed addressing drive is prevented, so that it is possible to secure a stable sustain margin. Thus, it is possible to reduce time for addressing and to improve a driving efficiency of the PDP.

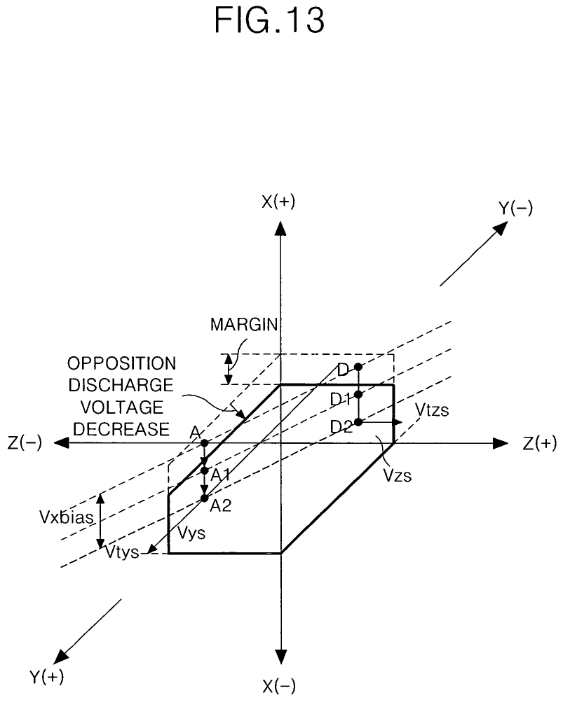

FIG. 13 is a graph showing a motion of the wall voltage of the discharge cells in accordance with the direct current voltage applied to the address electrode in the sustaining period.

Referring to FIG. 13, the wall voltage of the on cells moves from the interior of the hexagonal type voltage closed curve to a lower part as the positive direct current voltage Vxbias supplied to the address electrode X becomes larger. In other words, if the positive direct current voltage Vxbias supplied to the address electrode X becomes larger, then the wall voltage of the on cells moves to a center of the voltage closed curve interior. Accordingly, the self-erasing discharge generated in the discharge cells located at the voltage closed curve exterior is prevented. Thus, it is possible to more secure a stable sustain margin.

On the other hand, if a very high positive direct current voltage Vxbias is applied, each of the first and the second sustaining pulses Vys and Vzs becomes smaller than the first opposition discharge initiate voltage Vtxy, initiating the discharge between the address electrode X and the scan electrode Y, and the second opposition discharge initiate voltage Vtxz, initiating a discharge between the address electrode X and the sustain electrode Z. Thus, the positive direct current voltage Vxbias supplied to the address electrode X during the sustaining period should be determined in a larger range than the first opposition discharge initiate voltage Vtxy, initiating the discharge between the address electrode X and the scan electrode Y, and the second opposition discharge initiate voltage Vtxz, initiating the discharge between the address electrode X and the sustain electrode Z.

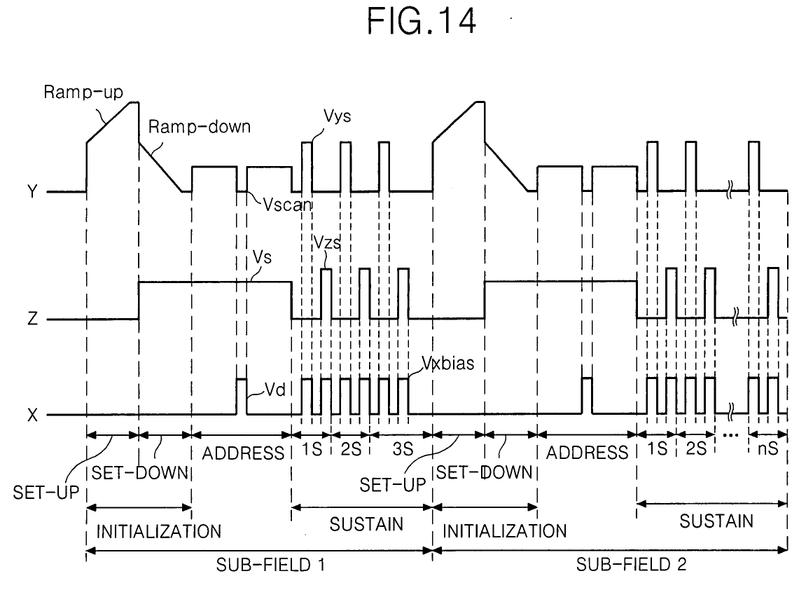

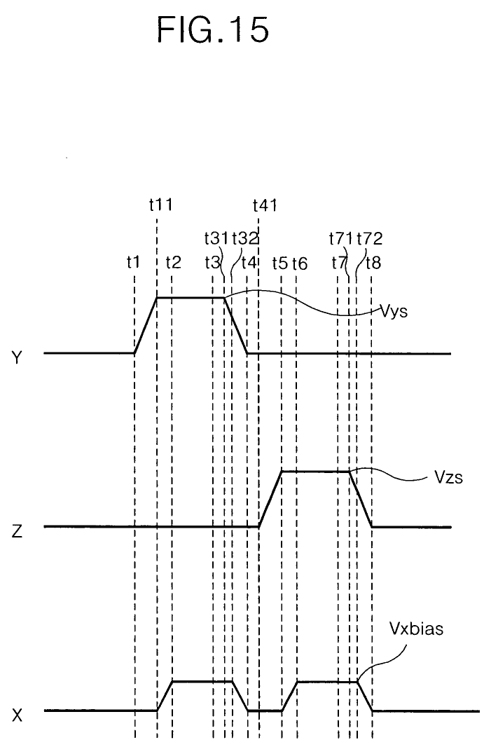

FIG. 14 is a diagram showing a driving waveform of a PDP according to another embodiment of the present invention, and FIG. 15 is a diagram showing a timing of pulses applied to a scan electrode, a sustain electrode, and an address electrode in a sustaining period in the driving waveform shown in FIG. 14.

Herein, the initialization period and the address period are the same as the method of driving of the PDP according to the embodiment of the present invention, so t that their detailed descriptions will be omitted.

In the sustaining period, the first and the second sustaining pulses Vys and Vzs are alternatively applied to the scan electrodes Y and the sustain electrodes Z. In this connection, each of the first and the second sustaining pulses Vys and Vzs becomes larger than the first opposition discharge initiate voltage Vtxy, initiating the discharge between the address electrode X and the scan electrode Y, and the second opposition discharge initiate voltage Vtxz, initiating the discharge between the address electrode X and the sustain electrode Z.

Such the first and the second sustaining pulses Vys and Vzs, as shown in FIG. 15, include: a rising period (between t1 and t11, and t41 and t5) when the sustaining pulse rises; a sustaining period (between t11 and t31, and t5 and t71) when the sustaining pulse is sustaining; and a falling period (between t31 and t4, and t71 and t8) when the sustaining pulse is falling.

As the wall voltage within the cell is added to the first and the second sustaining pulses Vys and Vzs, a sustain discharge is generated between the scan electrode Y and the sustain electrode Z in a surface-discharge type in the cell selected by the address discharge whenever the sustaining pulses Vys and Vzs are applied. Further, during the sustaining period, when the first and the second sustaining pulses Vys and Vzs are applied to the scan electrodes Y and the sustain electrodes Z, a positive auxiliary pulse Vxbias, having the value identical to that of the data pulse Vd applied to the address electrode X during the address period, is applied to the address electrodes X. In this connection, the positive auxiliary pulse Vxbias is applied within a period of the sustaining pulse width applied to the scan electrode Y and the sustain electrode Z during the sustaining period. In other words, the positive auxiliary pulse Vxbias rises during the first sustaining period (between t11 and t2, and t5 and t6) when the first and the second sustaining pulses Vys and Vzs are fixedly sustained, and the positive auxiliary pulse Vxbias maintains a fixed voltage value during the second sustaining period (between t2 and t31, and t6 and t71) when the first and the second sustaining pulses Vys and Vzs are fixedly sustained and during a first falling period (between t31 and t32, and t71 and t72) when the first and the second sustaining pulses Vys and Vzs are fallen. Further, the positive auxiliary pulse Vxvias falls during the second falling period (between t32 and t4 and between t72 and t78) when the first and the second sustaining pulses Vys and Vzs are fallen. Such a positive auxiliary pulse Vxbias might be changed in a range having a voltage larger than the first opposition discharge initiate voltage Vtxy, initiating the discharge between the address electrode X and the scan electrode Y, and the second opposition discharge initiate voltage Vtxz, initiating the discharge between the address electrode X and the sustain electrode Z.

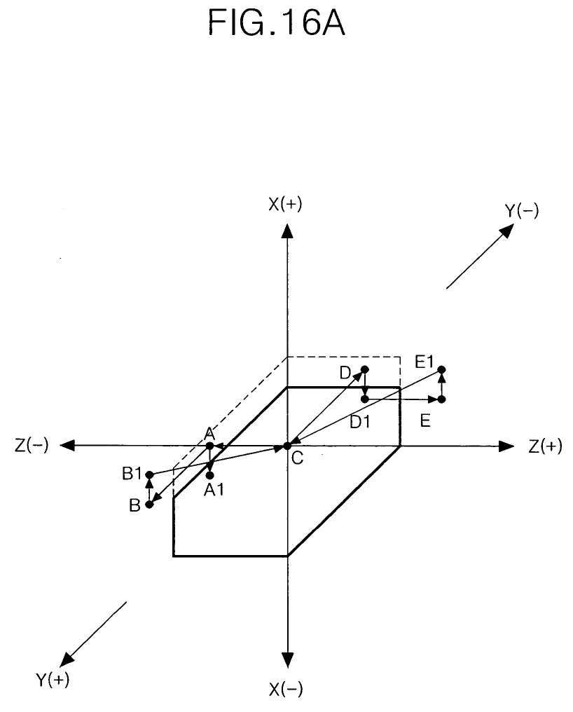

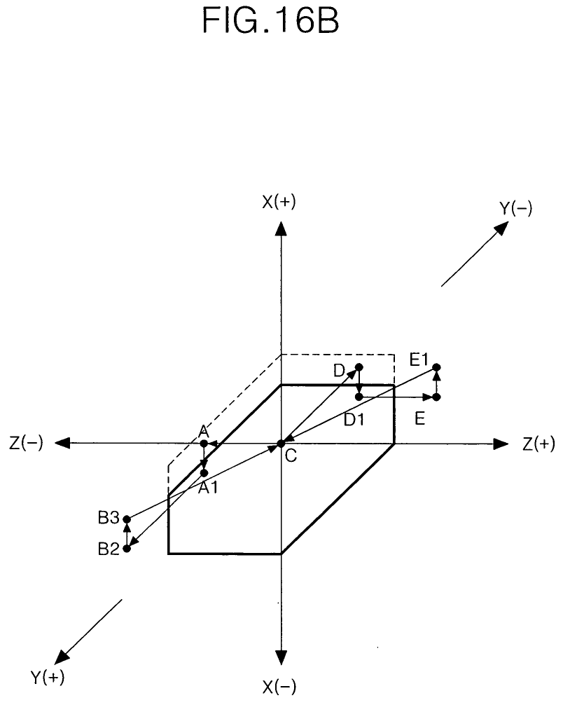

A principle of generating the sustain discharge generated in the scan electrode Y and the sustain electrode Z in accordance with an interval of the sustaining pulse shown in FIG. 15 will be described with the aid of a voltage closed curve having a hexagonal shape as shown in FIGS. 16A and 16B.

A wall voltage of on cells in which an address discharge is generated is located at an ‘A’ portion, X(−) axis, as shown in FIG. 16A. Thereafter, the wall voltage of the on cells located at the ‘A’ portion is added to the positive first sustaining pulse Vys, so that the wall voltage of the on cells moves to Y(+) axis via a surface-discharge area located at the third quarter-face of the graph, as shown in FIG. 7, at the point of t1 time when the positive first sustaining pulse Vys is applied to the scan electrode Y during the first sustaining period 1S of the sustaining period. In this connection, the wall voltage of the on cells moves from the ‘A’ portion to a ‘B’ portion by the first sustaining pulse Vys rising to the positive polarity at the point of t11 time and the wall voltage of the on cells located at the ‘A’ portion. During this period, since the wall voltage of the on cells is located at the exterior of the voltage closed curve, the sustain discharge is always generated between the sustain electrode Z and the scan electrode Y.

Thereafter, when a positive auxiliary pulse Vxbias is applied to the address electrode X, the wall voltage of on cells moves from the ‘B’ portion to a ‘B1’ portion by the positive auxiliary pulse Vxbias at the point of t2 time when the pulse Vxbias rises. Further, at the point of t3 time when the first sustaining pulse Vys and the auxiliary pulse Vxbias are maintained in a fixed voltage, wall charges are accumulated in the sustain electrode Z to thereby erase a discharge in the scan electrode Y. Accordingly, the wall voltage of the on cells moves from the ‘B1’ portion to a ‘C’ portion. And then, at the point of t4 time when the first sustaining pulse Vys applied to the scan electrode Y is eliminated, the wall voltage of the on cells moves from the ‘C’ portion to a ‘D’ portion by the eliminated first sustaining pulse Vys. At the same time, since the auxiliary pulse Vxbias applied to the address electrode X is eliminated in the point of the same time, wall voltage moves from the ‘D’ portion to a ‘D1’ portion by the eliminated auxiliary pulse Vxbias.

The wall voltage of the on cells located at the ‘D1’ portion is added to the positive second sustaining pulse Vzs, so that the wall voltage of the on cells moves to Z(+) axis via a surface-discharge area located at the first quarter-face of the graph, as shown in FIG. 8, at the point of t41 time when the positive second sustaining pulse Vzs is applied to the sustain electrode Z during the first sustaining period 1S of the sustaining period. Accordingly, the wall voltage of the on cells moves from the ‘D1’ portion to an ‘E’ portion by the second sustaining pulse Vzs rising to the positive polarity at the point of t5 time and the wall voltage of the on cells located at the ‘D1’ portion, and a sustain discharge between the sustain electrode Z and the scan electrode Y is generated in the discharge cells. Thereafter, when a positive auxiliary pulse Vxbias is applied to the address electrode X, the wall voltage of on cells moves from the ‘E’ portion to an ‘E1’ portion by the positive auxiliary pulse Vxbias at the point of t6 time when the pulse Vxbias rises. Further, at the point of t7 time when the second sustaining pulse Vzs and the auxiliary pulse Vxbias are maintained in a fixed voltage, wall charges are accumulated in the scan electrode Y to thereby erase a discharge in the sustain electrode Z. Accordingly, the wall voltage of the on cells moves from the ‘E1’ portion to a ‘C’ portion. And then, at the point of t8 time when the second sustaining pulse Vzs applied to the sustain electrode Z is eliminated, the wall voltage of the on cells moves from the ‘C’ portion to an ‘A’ portion by the eliminated second sustaining pulse Vzs. At the same time, since the auxiliary pulse Vxbias applied to the address electrode X is eliminated, wall voltage moves from the ‘A’ portion to an ‘A1’ portion by the eliminated auxiliary pulse Vxbias.

The wall voltage of on cells in which a sustain discharge is generated by the first and the second sustaining pulses Vys and Vzs applied to the scan electrode Y and the sustain electrode Z during the first sustaining period 1S of the sustaining period is located at the ‘A1’ portion, the third quarter-face of the voltage closed curve, as shown in FIG. 16B. Thereafter, the wall voltage of the on cells located at the ‘A1’ portion is added to the positive first sustaining pulse Vys, so that the wall voltage of the on cells moves to Y(+) axis via a surface-discharge area located at the third quarter-face of the graph, as shown in FIG. 7, at the point of t1 time when the positive first sustaining pulse Vys is applied to the scan electrode Y during a second sustaining period 2S of the sustaining period. In this connection, the wall voltage of the on cells moves from the ‘A1’ portion to a ‘B2’ portion by the first sustaining pulse Vys rising to the positive polarity at the point of t11 time and the wall voltage of the on cells located at the ‘A1’ portion, and a sustain discharge between the scan electrode Y and the sustain electrode Z is generated in the discharge cells.

Thereafter, when a positive auxiliary pulse Vxbias is applied to the address electrode X, the wall voltage of on cells moves from the ‘B2’ portion to a ‘B3’ portion by the positive auxiliary pulse Vxbias at the point of t2 time when the pulse Vxbias rises. Further, at the point of t3 time when the first sustaining pulse Vys and the auxiliary pulse Vxbias are maintained in a fixed voltage, wall charges are accumulated in the sustain electrode Z to thereby erase a discharge in the scan electrode Y. Accordingly, the wall voltage of the on cells moves from the ‘B3’ portion to a ‘C’ portion. And then, at the point of t4 time when the first sustaining pulse Vys applied to the scan electrode Y is eliminated, the wall voltage of the on cells moves from the ‘C’ portion to a ‘D’ portion by the eliminated first sustaining pulse Vys. At the same time, since the auxiliary pulse Vxbias applied to the address electrode X is eliminated in the point of the same time, wall voltage moves from the ‘D’ portion to a ‘D1’ portion by the eliminated auxiliary pulse Vxbias.

The wall voltage of the on cells located at the ‘D1’ portion is added to the positive second sustaining pulse Vzs, so that the wall voltage of the on cells moves to Z(+) axis via a surface-discharge area located at the first quarter-face of the graph, as shown in FIG. 8, at the point of t41 time when the positive second sustaining pulse Vzs is applied to the sustain electrode Z during the second sustaining period 2S of the sustaining period. In this connection, the wall voltage of the on cells moves from the ‘D1’ portion to the ‘E’ portion by the second sustaining pulse Vzs rising to the positive polarity at the point of t5 time and the wall voltage of the on cells located at the ‘D1’ portion, and a sustain discharge between the sustain electrode Z and the scan electrode Y is generated in the discharge cells. Thereafter, when a positive auxiliary pulse Vxbias is applied to the address electrode X, the wall voltage of on cells moves from the ‘E’ portion to the ‘E1’ portion by the positive auxiliary pulse Vxbias at the point of t6 time when the pulse Vxbias rises. Further, at the point of t7 time when the second sustaining pulse Vzs and the auxiliary pulse Vxbias are maintained in a fixed voltage, wall charges are accumulated in the scan electrode Y to thereby erase a discharge in the sustain electrode Z. Accordingly, the wall voltage of the on cells moves from the ‘E1’ portion to the ‘C’ portion. And then, at the point of t8 time when the second sustaining pulse Vzs applied to the sustain electrode Z is eliminated, the wall voltage of the on cells moves from the ‘C’ portion to the ‘A’ portion by the eliminated second sustaining pulse Vzs. At the same time, since the auxiliary pulse Vxbias applied to the address electrode X is eliminated, wall voltage moves from the ‘A’ portion to the ‘A1’ portion by the eliminated auxiliary pulse Vxbias.

As described above, in the method of driving the PDP according to another embodiment of the present invention, when the first and the second sustaining pulse Vys and Vzs are applied to the scan electrodes Y and the sustain electrodes Z, the positive auxiliary pulse Vxbias is applied to the address electrode X to thereby move the wall voltage of the discharge cells (on cells) located the exterior of the voltage closed curve to the interior of the voltage closed curve when the second sustaining pulse Vzs to the sustain electrode Z. Further, in the method of driving the PDP according to another embodiment of the present invention, the first and second sustaining pulses Vys and Vzs are respectively applied to the scan electrodes Y and the sustain electrodes Z during the first sustaining period 1S of the sustaining period to thereby move the wall voltage of the discharge cells (on cells) existed at the exterior of the voltage closed curve to the interior of the voltage closed curve. Accordingly, since the discharge cells (on cells) in which the sustain discharge is generated during the first sustaining period 1S is located at the interior of the voltage closed curve, the self erasing discharge is not generated on the discharge cells (on cells) as shown in FIG. 16B even through the first and the second sustaining pulses Vys and Vzs are respectively applied to the scan electrodes Y and the sustain electrode Z. Thus, it is possible to secure a stable sustain margin. In other words, in the method of driving the PDP according to another embodiment of the present invention, after the process shown in FIG. 16A is performed during the first sustaining period 1S of the sustaining period, the process shown in FIG. 16B is repeated during the second to the nth sustaining periods (2S to nS). Accordingly, in the method of driving the PDP according to another embodiment of the present invention, time for addressing can be reduced and a driving efficiency of the PDP can be increased.

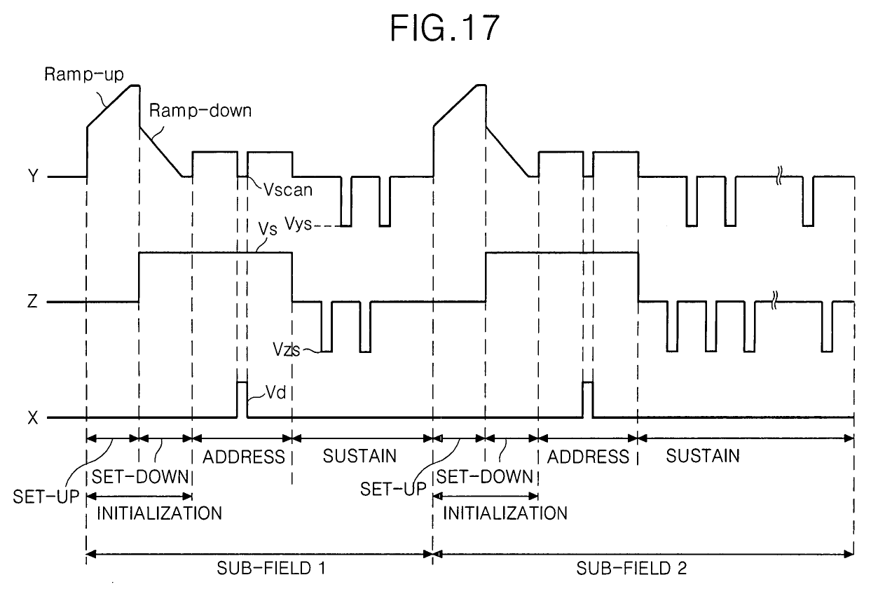

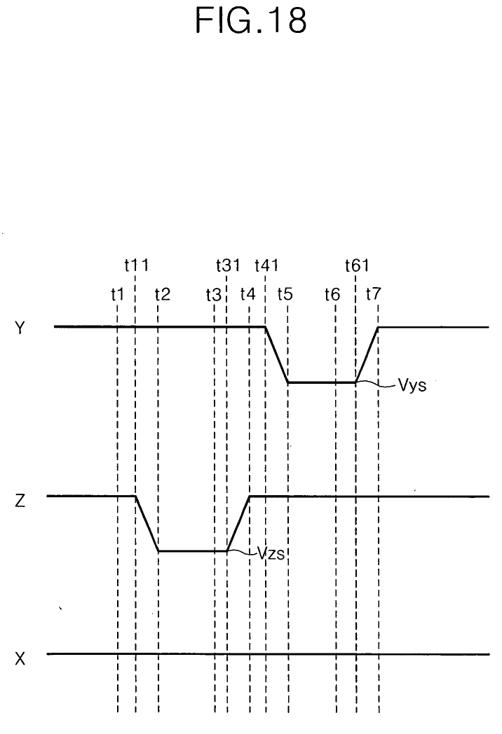

FIG. 17 is a diagram showing a driving waveform of a PDP according to still another embodiment of the present invention, and FIG. 18 is a diagram showing a timing of pulses applied to a scan electrode, a sustain electrode, and an address electrode in a sustaining period in the driving waveform shown in FIG. 17.

Herein, the initialization period and the address period are the same as the method of driving of the PDP according to the embodiment of the present invention, so t that their detailed descriptions will be omitted.

In the sustaining period, negative first and the second sustaining pulses Vzs and Vys are alternatively applied to the sustain electrodes Z and the scan electrodes Y. In this connection, each of the first and the second sustaining pulses Vzs and Vys becomes larger than the first opposition discharge initiate voltage Vtxz, initiating the discharge between the address electrode X and the sustain electrode Z, and the second opposition discharge initiate voltage Vtxy, initiating the discharge between the address electrode X and the scan electrode Y. Such the first and the second sustaining pulses Vzs and Vys include: a falling period (between t11 and t2 and between t41 and t5) when the sustaining pulse falls to a negative polarity; a sustaining period (between t2 and t31 and between t5 and t61) when the sustaining pulse is sustained; and a rising period (between t31 and t4 and between t61 and t7) when the sustaining pulse rises to the ground voltage. When the negative first and second sustaining pulses Vzs and Vys are respectively applied to the sustain electrodes Z and the scan electrodes Y, as the wall voltage within the cell is added to the first and the second sustaining pulses Vzs and Vys, a sustain discharge is generated between the sustain electrode Z and the scan electrode Y in a surface-discharge type in the cell selected by the address discharge whenever the sustaining pulses Vzs and Vys are applied. Such the first and the second sustaining pulses Vzs and Vys are formed in the same dimension.

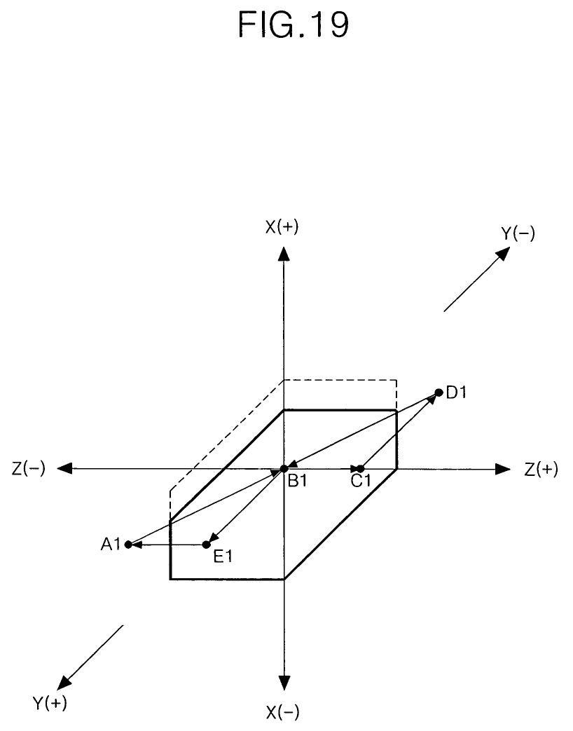

A principle of generating the sustain discharge generated in the scan electrode Y and the sustain electrode Z in accordance with an interval of the sustaining pulse shown in FIG. 18 will be described with the aid of a voltage closed curve having a hexagonal shape as shown in FIG. 19.

A wall voltage of discharge cells (on cells) in which an address discharge is generated is located at an ‘E1’ portion, the third quarter-face of the graph, as shown in FIG. 19. Thereafter, the wall voltage of the on cells located at the ‘E1’ portion is added to the negative first sustaining pulse Vzs, so that the wall charge of the on cells moves to Z(−) axis via a surface-discharge area located at the third quarter-face of the graph at the point of t11 time when the negative first sustaining pulse Vzs is applied to the sustain electrode Z. In this connection, the wall voltage of the on cells moves from the ‘E1’ portion to an ‘A1’ portion by the first sustaining pulse Vzs falling to the negative polarity and the wall voltage of the on cells located at the ‘E1’ portion at the point of t2 time, and a sustain discharge between the sustain electrode Z and the scan electrode Y is generated in the discharge cells. At the point of t3 time when the first sustaining pulse Vzs is maintained, wall charges are accumulated in the scan electrode Y, so that a discharge is erased in the sustain electrode Z, thus, the wall voltage of the on cells moves from the ‘A1’ portion to a ‘B1’ portion. And then, at the point of t4 time when the first sustaining pulse Vzs applied to the sustain electrode Z is eliminated, the wall voltage of the on cells moves from the ‘B1’ portion to a ‘C1’ portion by the eliminated first sustaining pulse Vzs.

At the point of t41 time when the second sustaining pulse Vys is applied to the scan electrode Y, the wall voltage of the on cells located at the ‘C1’ potion is added to the negative second sustaining pulse Vys, so that the wall voltage moves to Y(−) axis through a surface-discharge area located at the first quarter-face of the graph. Accordingly, at the point of t5 time, the wall voltage of the on cells moves from the ‘C1’ potion to a ‘D1’ portion by the second sustaining pulse Vys falling to the negative polarity and the wall voltage of the on cells located at the ‘C1’ portion, and a sustain discharge between the scan electrode Y and the sustain electrode Z is generated in the discharge cells. At the point of t6 time when the second sustaining pulse Vys is maintained, wall charges are accumulated in the sustain electrode Z, so that a discharge is erased in the scan electrode Y, thus, the wall voltage of the on cells moves from the ‘D1’ portion to the ‘B1’ portion. And then, at the point of t7 time when the second sustaining pulse Vys applied to the scan electrode Y is eliminated, the wall voltage of the on cells moves from the ‘B1’ portion to the ‘E1’ portion by the eliminated second sustaining pulse Vys.

In real, the PDP repeats the above-mentioned processes of a predetermined frequency during the sustaining period to thereby cause sustain discharges. Accordingly, the discharge cells in which the discharge is generated repeat the process shown in FIG. 19.

In the method of driving the PDP according to still another embodiment of the present invention, the negative sustaining pulses Vys and Vzs are applied to the scan electrode Y and the sustain electrode Z in the sustaining period to thereby locate the wall charges at the interior of the hexagon voltage closed curve, so that it is possible to secure a stable sustain margin. Accordingly, it is possible to reduce time for addressing and to increase a driving efficiency of the PDP.

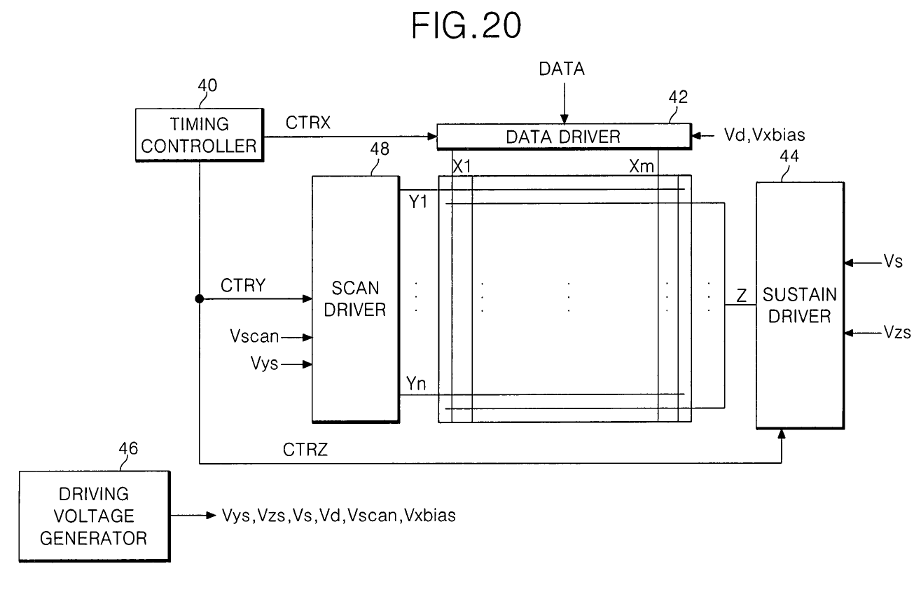

FIG. 20 is a diagram showing a driving apparatus for generating a driving waveform of the PDP shown in FIGS. 10, 14, and 17.

Referring to FIG. 20, the driving apparatus of the PDP includes: a data driver 42 connected to address electrodes X1 to Xm of the PDP; a scan driver 48 connected to scan electrodes Y1 to Yn of the PDP; a sustain driver 44 connected to sustain electrodes Z of the PDP; a driving voltage generator 46 for supplying driving voltages necessary for the drivers 42, 44 and 48; and a timing controller 40 for controlling each of the drivers 42, 44 and 48.

The data driver 42 is supplied with data that is subjected to an inverse gamma correction and error diffusion by an inverse gamma correction circuit and an error diffusion circuit (not shown) and then mapped by a sub-field mapping circuit to each sub-field. The data driver 42 samples the data in response to a timing control signal CTRX provided from the timing controller 40. The sampled data is supplied to the address electrodes X1 to Xm by one horizontal line for each one horizontal period. Herein, the timing control signal CTRX provided to the data driver 42 includes a sampling clock for sampling the data, and a switching control signal for controlling on/off switching time of an energy recovery circuit and a driving switch device. A data voltage supplied from the data driver 42 to the address electrodes X1 to Xm is used to select an off-cell of a non-selection.

The scan driver 48 supplies the falling ramp waveform to the scan electrodes Y1 to Yn in the reset period under the control of the timing controller 40 and then supplies the rising ramp waveform to the scan electrodes Y1 to Yn to initialize all cells. Moreover, the scan driver 48 supplies sequentially a positive scan pulse to the scan electrodes Y1 to Yn in the address period under the control of the timing controller 40, and at the same time supplies a sustaining pulse to the scan electrodes Y1 to Yn to cause the sustain discharge in the cells selected by the address discharge. A timing control signal CTRY applied to the scan driver 48 includes a switching control signal for controlling on/off switching time of switching devices in the scan driver 48.

The sustain driver 44 supplies an initializing waveform substantially identical to the initializing waveform generated from the scan driver 48, that is, a waveform wherein the falling ramp waveform is continued to the rising ramp waveform, to the sustain electrodes Z, under the control of the timing controller 40, in the reset period. The sustain driver 44 is alternately driven along with the scan driver 48, to supply the sustaining pulses to the sustain electrodes Z in the sustaining period. A timing control signal CTRZ applied to the sustain driver 44 includes a switching control signal for controlling on/off switching time of switching devices in the sustain driver 44.

The driving voltage generator 46 includes a direct current-direct current converter (DC-DC Converter) for converting a system power from a main board (not shown) to a voltage level of output voltage by using a pulse width modulation system. A driving voltage outputted from the driving voltage generator 46 includes a positive set-up voltage Vsetup corresponding to a upper limit voltage of the rising ramp waveform Ramp-up, a positive scan voltage Vscan, a positive direct current voltage Vxbias, first to third sustain voltages Vs, Vys, Vzs, and a positive data voltage Vd.

The timing controller 40 is supplied with a vertical/horizontal synchronization signals and a main clock, and generates the timing control signals CTRX, CTRY and CTRZ necessary to drive the drivers 42,44 and 48, respectively, using the synchronization signals and the main clock.

Such a driving apparatus of the PDP supplies the positive direct current volage Vxbias, supplied from the date driver 42, to the address electrode X in when the positive direct current Vxbias from the driving voltage generator 46 is supplied to the data driver 42. In this connection, first and second sustaining pulses Vys and Vzs generated from the driving voltage generator 46 maintain the ground voltage. Accordingly, the driving waveform of the PDP according to the embodiment of the present invention shown in FIG. 10 is generated.

Further, the driving apparatus of the PDP alternatively supplies the first and the second sustaining pulses Vys and Vzs to the scan electrode Y and the sustain electrode Z in the sustaining period when the positive first and second sustaining pulses Vys and Vzs are respectively to the scan driver 48 and the sustain driver 44. At the same time, the data driver 42 applies the positive auxiliary pulse Vxbias generated from the driving voltage generator 46 to the address electrode X in the sustaining period. In this connection, the auxiliary pulse Vxbias is applied to the address electrode X when the first and the second sustaining pulses Vys and Vzs are respectively applied to the scan electrode Y and the sustain electrode Z. Accordingly, the driving waveform of the PDP according to another embodiment of the present invention shown in FIG. 14 is generated.

Finally, the driving apparatus of the PDP supplies the negative first and second sustaining pulses Vzs and Vys generated from the driving voltage generator 46 to the sustain driver 44 and the scan driver 48. In this connection, the sustain driver 44 and the scan driver 48 alternatively apply the first and the second sustaining pulses Vzs and Vys to the sustain electrode Z and the scan electrode Y in the sustaining period. Accordingly, the driving waveform according to still another embodiment of the present invention shown in FIG. 17 is generated.

Although embodiments according to the present invention are described to the method of controlling the wall charge capable of preventing the self-erase for the sustaining period, it is also possible to be applied to the initialization period or the address period.

As described above, in the method of driving the PDP according to the present invention, the voltage is applied to the address electrode to move the wall voltage of the discharge cells located at the exterior of the hexagonal voltage closed curve into the interior of the voltage closed curve after the address discharge in the sustaining period, so that the self-erasing discharge can be prevented. Thus, it is possible to secure a stable sustain margin. Accordingly, it is possible to reduce time for addressing and to improve a driving efficiency of the PDP.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

What is claimed is:

1. A method of driving a plasma display panel, time-dividedly driven by dividing a plurality scan electrodes, sustain electrodes, and address electrodes into an initialization period, an address period, and a sustaining period, comprising:
applying a positive direct current voltage to the address electrode for the sustaining period; and
applying a first positive sustaining pulse to the scan electrode and a second positive sustaining pulse to the sustain electrode for the sustaining period.

2. The method according to claim 1, wherein the voltage of the first sustaining pulse is larger than the voltage capable of causing an opposition discharge between the address electrodes and the scan electrodes or the address electrodes and the sustain electrodes.

3. The method according to claim 1, wherein the direct current voltage is substantially equal to the data voltage applied to the address electrodes for the address period to select a discharge cell.

4. The method according to claim 1, wherein the direct current voltage is smaller than the sustain voltage.

5. A method of driving a plasma display panel, time-dividedly driven by dividing a plurality scan electrodes, sustain electrodes, and address electrodes into an initialization period, an address period, and a sustaining period, comprising:
alternatively applying a positive sustaining pulse to the scan electrodes and the sustain electrodes for the sustaining period; and
supplying a positive auxiliary pulse corresponding to the sustaining pulse to the address electrodes at least one time.

6. The method according to claim 5, wherein the sustaining pulse is larger than a voltage capable of causing an opposition discharge between the address electrodes and the scan electrodes or the address electrodes and the sustain electrodes.

7. The method according to claim 5, wherein the voltage of the auxiliary pulse is substantially same to the data voltage applied to the address electrodes for the address period in order to select a discharge cell.

8. The method according to claim 5, wherein the auxiliary pulse is smaller than the sustain voltage

9. The method according to claim 5, wherein the voltage of the auxiliary pulse maintains a high potential after is risen for the high potential maintaining period of the sustaining pulse, maintains the high potential for the primary voltage falling period of the sustaining pulse, and falls to a low potential for a secondary voltage falling period of the sustaining pulse.

10. A method of driving a plasma display panel, time-dividedly driven by dividing a plurality scan electrodes, sustain electrodes, and address electrodes into an initialization period, an address period, and a sustaining period, comprising:
alternatively applying a negative sustaining pulse to the sustain electrodes and the scan electrodes for the sustaining period.

11. The method according to claim 10, wherein the sustaining pulse is larger than a voltage capable of causing an opposition discharge between the address electrodes and the sustain electrodes or the address electrodes and the scan electrodes.

12. The method according to claim 10, wherein the sustaining pulse is applied to the sustain electrodes, and then is applied to the scan electrode.

13. A method of driving a plasma display panel including a sustain electrode, an address electrode and a scan electrode based on a non-discharge area defined on the coordinates having X, Y and Z axes and a discharge area defined at exterior of the non-discharge area, wherein the Z axis represents the voltage applied to the sustain electrode, the X axis crossing the Z axis represents a voltage applied to the address electrode, and the Y axis passes through a point of cross of both the Z axis and the X axis and exists at a first quarter-face and a third quarter-face of an orthogonal coordinates formed of the Z axis and the X axis, comprising:
applying a first voltage to the address electrode for the sustaining period to move a wall voltage of an on cell existed at the discharge area near the Z axis to a first location of the non-discharge area;
applying a second voltage to the scan electrode to move the wall charge of the on cell existed at the first location of the non-discharge area to a first location of the discharge area;
maintaining a voltage of the scan electrode with the second voltage and inducing an accumulation of wall charge on the sustain electrode to move the wall voltage of the on cell from the first location of the discharge area to a second location of the non-discharge area;
lowering the voltage of the scan electrode to move the wall voltage of the on cell from the second location of the non-discharge area to a third location of the non-discharge area;
applying a third voltage to the sustain electrode to move the wall voltage of the on cell from the third location of the non-discharge area to a second location of the discharge area;
maintaining the a voltage of the sustain electrode with the third voltage and inducing an accumulation of a wall charge on the scan electrode to return the wall voltage of the on cell from the second location of the discharge area to the second location of the non-discharge area; and
lowering the voltage of the sustain electrode to return the wall charge of the on cell from the second location of the non-discharge to the first location of the discharge area.

14. The method according to claim 13, wherein the first voltage is substantially a positive direct current voltage.

15. The method according to claim 13, wherein the second and the third voltages are larger than the voltage capable of causing an opposition discharge between the address electrode and the scan electrode or the address electrode and the sustain electrode.

16. The method according to claim 13, wherein the first voltage is smaller than the second and the third voltages.

17. The method according to claim 13, wherein the first location of the non-discharge area and the first location of the discharge area are respectively existed on the third quarter-face;
the second location of the non-discharge area is existed near the X axis between the third quarter-face and the fourth quarter-face; and
the third location of the non-discharge area and the second location of the discharge area are respectively existed on the first quarter-face.

18. A method of driving a plasma display panel including a sustain electrode, an address electrode and a scan electrode based on a non-discharge area defined on the coordinates having X, Y and Z axes and a discharge area defined at exterior of the non-discharge area, wherein the Z axis represents the voltage applied to the sustain electrode, the X axis crossing the Z axis represents a voltage applied to the address electrode, and the Y axis passes through a point of cross of both the Z axis and the X axis and exists at a first quarter-face and a third quarter-face of an orthogonal coordinates formed of the Z axis and the X axis, comprising:
a first step of applying a first voltage to the scan electrode for the sustaining period to move a wall voltage of an on cell from a first location of the discharge area to a second location of the discharge area;
a second step of applying a second voltage to the address electrode while a voltage of the scan electrode is maintained with the first voltage to move the wall voltage of the on cell from the second location of the discharge area to a third location of the discharge area;
a third step of maintaining the voltages of both the scan electrode and the address electrode and inducing an accumulation of a wall charge on the sustain electrode to move the wall voltage of the on cell from the third location of the discharge area to a first location of the non-discharge area;
a fourth step of lowering the voltage of the scan electrode while the voltage of the address electrode is maintained with the second voltage to move the wall voltage of the on cell from the first location of the non-discharge area to a fourth location of the discharge area;
a fifth step of lowering the voltage of the address electrode while the voltage of the scan electrode is lowered to move the wall voltage of the on cell from the fourth location of the discharge area to a second location of the non-discharge area;
a sixth step of applying a third voltage to the sustain electrode to move the wall voltage: of the on cell from the second location of the non-discharge to a fifth location of the discharge area;
a seventh step of applying the second voltage to the address electrode while the voltage of the sustain electrode is maintained with the third voltage to move the wall voltage of the on cell from the fifth location of the discharge area to a sixth location of the discharge area;
an eighth step of maintaining the voltage both the sustain electrode and the address electrode to return the wall voltage of the on cell from the sixth location of the discharge area to the first location of the non-discharge area;
a ninth step of lowering the voltage of the sustain electrode while the voltage of the address electrode is maintained to return the wall voltage of the on cell from the first location of the non-discharge area to the first location of the discharge area;
a tenth step of lowering the voltage of the address electrode while the voltage of the sustain electrode is lowered to move the wall charge of the on cell from the first location of the discharge area to a third location of the non-discharge area;
an eleventh step of applying the first voltage to the scan electrode to move the wall voltage of the on cell from the second location area of the non-discharge area to a seventh location of the discharge area;
a twelfth step of applying the second voltage to the address electrode while the voltage of the scan electrode is maintained with the first voltage to move the wall voltage of the on cell form the seventh location of the discharge area to an eighth location of the discharge area;
a thirteenth step of maintaining the voltage of both the scan electrode and the address electrode and-inducing an accumulation of a wall charge on the sustain electrode to return the wall voltage of the on cell form the eighth location of the discharge area to the first location of the non-discharge area;
a fourteenth step of lowering the voltage of the scan electrode while the voltage of the address electrode is maintained to move the wall voltage of the on cell from the first location of the non-discharge area to the fourth location of the discharge area;
a fifteenth step of lowering the voltage of the address electrode while the voltage of the scan electrode is lowered to move the wall voltage of the on cell from the fourth location of the discharge area to the second location of the non-discharge area;
a sixteenth step of applying the third voltage to the sustain electrode to move the wall voltage of the on cell from the second location of the non-discharge area to the fifth location of the discharge area;
a seventeenth step of applying the second voltage to the address electrode while the voltage of the sustain electrode is maintained with the third voltage to move the wall charge of the on cell form the fifth location of the discharge area to the sixth location of the discharge area;
an eighteenth step of maintaining the voltage of both the sustain electrode and the address electrode to return the wall voltage of the on cell from the sixth location of the discharge area to the first location of the non-discharge area;
a nineteenth step of lowering the voltage of the sustain electrode while the voltage of the address electrode is maintained to move the wall voltage of the on cell from the first location of the non-discharge area to the first location of the discharge area; and
a twentieth step of lowering the voltage of the address electrode while the voltage of the sustain electrode is lowered to move the wall voltage of the on cell from the first location of the discharge area to the third location of the non-discharge area.

19. The method according to claim 18, wherein the on cells in which a sustain discharge is generated among the first step to the tenth step repeat the eleventh step to the twentieth step for the remaining sustaining period.

20. The method according to claim 18, wherein the first voltage is larger than the voltage capable of causing a discharge between the address electrode and the scan electrode.

21. The method according to claim 18, wherein the second voltage is substantially same to the data voltage applied to the address electrode for the address period in order to select a discharge cell.

22. The method according to claim 21, wherein the second voltage: rises for the first sustaining period when the first and the third voltages are constantly maintained; is constantly maintained for the second sustaining period when the first and the third voltages are constantly maintained and the first falling period when the first and the third voltages are fallen; and falls for the second falling period when the first and the third voltages are fallen.

23. The method according to claim 21, wherein the third and the first voltages are larger than the voltage capable of causing a discharge between the address electrode and the sustain electrode or the address electrode and the scan electrode.

24. The method according to claim 18, wherein the second voltage is smaller than the first and the third voltages.

25. The method according to claim 18, wherein the first location of the discharge area is existed near the Z axis between the second quarter-face and the third quarter-face;
the second, the third, the seventh, and the eighth locations of the discharge area are existed on the third quarter-face;
the fourth, the fifth, and the sixth locations of the discharge area, and the second and the third locations of the non-discharge area are existed on the first quarter-face; and
the first location of the non-discharge area is existed near a point crossing both the Z axis and the X axis.

26. A method of driving a plasma display panel including a sustain electrode, an address electrode and a scan electrode based on a non-discharge area defined on the coordinates having X, Y and Z axes and a discharge area defined at exterior of the non-discharge area, wherein the Z axis represents the voltage applied to the sustain electrode, the X axis crossing the Z axis represents a voltage applied to the address electrode, and the Y axis passes through a point of cross of both the Z axis and the X axis and exists at a first quarter-face and a third quarter-face of an orthogonal coordinates formed of the Z axis and the X axis, comprising:
applying a negative first voltage to the sustain electrode for the sustaining period to move a wall voltage of an on cell existed at a first initialization location of the non-discharge area to a first location of the discharge area;
maintaining a voltage of the sustain electrode and inducing an accumulation of a wall charge on the scan electrode to move the wall voltage of the on cell from the first location of the discharge area to a first location of the non-discharge area;
lowering the voltage of the sustain electrode to move the wall voltage of the on cell from the first location of the non-discharge area to a second location of the non-discharge area;
applying a negative second voltage to the scan electrode to move the wall voltage of the on cell from a second initialization location of the non-discharge area to a second location of the discharge area;
maintaining a voltage of the scan electrode and inducing an accumulation of a wall charge on the sustain electrode to return the wall voltage of the on cell from the second location of the discharge area to a second location of the non-discharge area; and
lowering the voltage of the scan electrode to return the wall voltage of the on cell from the second location of the non-discharge area to a third location of the non-discharge area.

27. The method according to claim 26, wherein the first and the second voltages are larger than the voltage capable of causing a discharge between the address electrode and the sustain electrode or the address electrode and the scan electrode.

28. The method according to claim 26, wherein the first initialization location of the non-discharge area, the first location of the discharge area, and the third location of the non-discharge area are existed on the third quarter-face;
the first location of the non-discharge area is existed near a point crossing both the X axis and the Z axis;
the second location of the non-discharge area is existed near the Z axis between the first quarter-face and the fourth quarter-face; and
the second initialization location of the non-discharge area is existed on the first quarter-face.
